(19) United States
(12) Patent Application Publication
(10) Pub. No.: US 2010/0248023 A1
(43) Pub. Date: Sep. 30, 2010

(54) NON-AQUEOUS ELECTROLYTE BATTERY

(75) Inventors: Sho Tsuruta, Kobe-shi (JP); Motoharu Saito, Kobe-shi (JP); Katsunori Yanagida, Kobe-shi (JP); Masahisa Fujimoto, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/732,912

(22) Filed: Mar. 26, 2010

(30) Foreign Application Priority Data
Mar. 27, 2009 (JP) 2009-078847

(51) Int. Cl. H01M 6/14

(52) U.S. Cl. 429/188

(57) ABSTRACT

A non-aqueous electrolyte battery has a working electrode 1 having a positive electrode active material, a counter electrode 2, and a non-aqueous electrolyte containing lithium. The positive electrode active material includes a lithium pre-doped transition metal oxide prepared by pre-doping lithium into a sodium-containing transition metal oxide having an initial charge-discharge efficiency of higher than 100% as determined by charging and discharging using a lithium metal negative electrode as a counter electrode, and the sodium-containing transition metal oxide is represented by the compositional formula NaₐLi_{b}MO_{2±α}, where 0.5≦a<1.0, 0<b≦0.5, 0≦α≦0.1, and M is at least one element selected from the group consisting of Ni, Co, and Mn.

### BACKGROUND OF THE INVENTION

1. Field of the Invention

The present invention relates to a non-aqueous electrolyte battery comprising a negative electrode, a non-aqueous electrolyte, and a positive electrode containing a positive electrode active material comprising a transition metal oxide.

2. Description of Related Art

Mobile information terminal devices such as mobile telephones, notebook computers, and PDAs have become smaller and lighter at a rapid pace in recent years. This has led to a demand for higher capacity batteries as the drive power source for the mobile information terminal devices. With their high energy density and high capacity, non-aqueous electrolyte batteries that perform charge and discharge by transferring lithium ions between the positive and negative electrodes have been widely used as the driving power source for the mobile information terminal devices.

As the mobile information terminal devices tend to have greater numbers of functions, such as moving picture playing functions and gaming functions, the power consumption of the devices tends to increase. It is therefore strongly desired that the non-aqueous electrolyte batteries used for the power sources of such devices have further higher capacities and higher performance to achieve longer battery life and improved output power. In addition, it is expected that the non-aqueous electrolyte batteries are used for not just the above-described applications but to power tools, power assisted bicycles, electric vehicles (EVs) and hybrid electric vehicles (HEVs). In order to meet such demand, it is also strongly desired that the non-aqueous electrolyte batteries have further higher capacity and lighter weight.

In order to increase the capacity of the non-aqueous electrolyte battery, it is necessary to use a positive electrode active material having a high energy density. To date, lithium-containing layered oxides such as LiCoO₂, LiNiO₂, and LiNi_{1/3}Mn_{1/3}Co_{1/3}O₂ have been studied. However, when more than half of the lithium is extracted from LiCoO₂ (when x≧0.5 in Li₁₋ₓCoO₂) in the case of using LiCoO₂ as the positive electrode active material, the crystal structure degrades, and the reversibility deteriorates. Thus, with LiCoO₂, the usable discharge capacity density is about 160 mAh/g, and it is difficult to achieve a higher energy density. Likewise, LiNiO₂ and LiNi_{1/3}Mn_{1/3}Co_{1/3}O₂ also have the same problem.

Many of the lithium-containing transition metal oxides that are layered compounds are difficult to synthesize, but it is known that the sodium-containing transition metal oxides that are layered compounds are relatively easy to synthesize (for example, see Japanese Published Unexamined Patent Application No. 2002-220231 (Patent Document 1)). It has been reported that among the sodium-containing transition metal oxides, the materials in which sodium of Na_{2/3}Ni_{1/3}Mn_{2/3}O₂, NaCo_{0.5}Mn_{0.}5₅O₂, and Na_{0.7}CoO₂ is ion-exchanged with lithium can reversibly intercalate and deintercalate lithium even at a high potential of 4.5 V or higher.

In addition, it has been proposed to pre-dope lithium into a positive electrode comprising a transition metal oxide having an O3 structure in order to reduce the initial irreversible capacity of a graphite negative electrode in constructing a battery, so that the battery capacity can be improved (for example, see Japanese Published Unexamined Patent Application No. 8-203525 (Patent Document 2)).

However, the proposal shown in Patent Document 1 has the following problem. When the foregoing material is subjected to ion-exchange, the lithium that is inserted is in a defective state, so the initial charge capacity is low relative to the discharge capacity. As a consequence, when the battery has a negative electrode material that does not contain lithium prior to initial charge and discharge, such as a graphite negative electrode and a silicon negative electrode, the battery capacity considerably decreases.

The proposal shown in Patent Document 2 has the problem of low charge-discharge efficiency. This is because the transition metal oxides having an O3 structure such as LiCoO₂ and LiNiO₂ inherently have low initial charge-discharge efficiency. So, when these transition metal oxides are pre-doped with lithium, the initial charge capacity of the positive electrode increases significantly, resulting in an increase in the irreversible capacity.

### BRIEF SUMMARY OF THE INVENTION

The present invention has been accomplished in view of the foregoing and other problems, and it is an object of the invention to provide a non-aqueous electrolyte battery that achieves higher battery capacity and an improvement in the initial charge-discharge efficiency.

In order to accomplish the foregoing and other objects, the present invention provides a non-aqueous electrolyte battery comprising: a positive electrode having a positive electrode active material; a negative electrode that does not contain lithium prior to initial charge and discharge; and a non-aqueous electrolyte containing lithium, wherein the positive electrode active material comprises a lithium pre-doped transition metal oxide prepared by pre-doping lithium into a sodium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0.5≦a<1.0, 0<b≦0.5, 0≦α≦0.1, and M is at least one element selected from the group consisting of Ni, Co, and Mn.

The present invention makes available a non-aqueous electrolyte battery that can achieve higher battery capacity and an improvement in the initial charge-discharge efficiency.

### BRIEF DESCRIPTION OF THE DRAWINGS

FIG. 1 is a cross-sectional view of a test cell used for the embodiments of the present invention.

### DETAILED DESCRIPTION OF THE INVENTION

A non-aqueous electrolyte battery according to the invention comprises: a positive electrode having a positive electrode active material; a negative electrode that does not contain lithium prior to initial charge and discharge; and a non-aqueous electrolyte containing lithium, wherein the positive electrode active material comprises a lithium pre-doped transition metal oxide prepared by pre-doping lithium into a sodium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0.5≦a<1.0, 0<b≦0.5, 0≦α≦0.1, and M is at least one element selected from the group consisting of Ni, Co, and Mn.

It should be noted that the phrase “an initial charge-discharge efficiency of higher than 100%” means an initial charge-discharge efficiency of higher than 100% as determined by charging and discharging using a lithium metal negative electrode as a counter electrode.

Since the sodium-containing transition metal oxide represented by such a compositional formula has a layered structure, the reversibility in the initial charge and discharge improves, and moreover, the crystal structure is stable even when charged to a high potential of 4.5 V or higher versus metallic lithium. As a result, a non-aqueous electrolyte battery with excellent cycle performance can be obtained. In addition, the pre-doping of the sodium-containing transition metal oxide with lithium compensates the lithium-ion defects, improving the initial charge-discharge efficiency. This will be discussed in more detail below in comparison with the related art.

The transition metal oxide having an O3 structure mentioned above is inherently a material having an initial charge-discharge efficiency of less than 100%. Therefore, pre-doping lithium into the material only serves to increase the irreversible capacity. That is, with the just-mentioned transition metal oxide, the lithium that originally exists in the positive electrode and the pre-doped lithium exit from the positive electrode during charge, but, during discharge, at most only the lithium that has originally existed in the positive electrode enters in the positive electrode. In other words, the pre-doping of lithium into the just-mentioned transition metal oxide means that lithium is pre-doped in an amount that exceeds the lithium-accepting capacity of the positive electrode. So, the pre-doping itself is not very meaningful.

On the other hand, the sodium-containing transition metal oxide having an initial charge-discharge efficiency of higher than 100% has a P2 structure. Therefore, during charge, the lithium and sodium that originally exist in the positive electrode exit from the positive electrode, but, during discharge, lithium enters the positive electrode in an amount more than the amount of lithium and sodium that have existed in the positive electrode. Thus, the pre-doping of lithium into the just-mentioned transition metal oxide means that lithium is pre-doped so as to fill the lithium-accepting capacity of the positive electrode. Therefore, the pre-doping is meaningful. Note that the later-described lithium-containing transition metal oxide having an initial charge-discharge efficiency of higher than 100% has an O2 structure, and it can exhibit the same advantageous effects as the sodium-containing transition metal oxide having an initial charge-discharge efficiency of higher than 100%.

It is desirable that the sodium-containing transition metal oxide be represented by the compositional formula NaₐLi_{b}MO_{2±α}, 0.5≦a<1.0, 0<b≦0.3, 0.5<a+b<1.0, 0≦α≦0.1, and M is at least one element selected from the group consisting of Ni, Co, and Mn. It is particularly desirable that the sodium-containing transition metal oxide be represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1, and the positive electrode active material be represented by the compositional formula NaₐLi_{b}Co_{c}Mn_{d}O₂, where 0.5≦a<1.0, 0<b≦0.5, 0≦c≦1, 0≦d≦1, and 0.8≦c+d≦1.1.

The just-mentioned sodium-containing transition metal oxide has a P2 structure with a space group P6₃ mmc. Therefore, when using such a sodium-containing transition metal oxide, it becomes possible to increase the capacity of the non-aqueous electrolyte battery.

The invention also provides a non-aqueous electrolyte battery comprising: a positive electrode having a positive electrode active material, a negative electrode having a negative electrode active material that does not contain lithium prior to initial charge and discharge, and a non-aqueous electrolyte containing lithium, wherein the positive electrode active material comprises a lithium pre-doped transition metal oxide prepared by pre-doping lithium into a lithium-containing transition metal oxide having an initial charge-discharge efficiency of higher than 100%, wherein the lithium pre-doped transition metal oxide is represented by the compositional formula NaₐLi_{b}MO_{2±α}, where 0≦a<0.1, 0.5≦b≦1.2, 0≦α≦0.1, and M is at least one element selected from the group consisting of Ni, Co, and Mn.

In addition to the same advantageous effects as described above, the following advantageous effects are obtained when the lithium-containing transition metal oxide having an initial charge-discharge efficiency of higher than 100% is used as the transition metal oxide pre-doped with lithium in place of the foregoing sodium-containing transition metal oxide having an initial charge-discharge efficiency of higher than 100%. With the use of the sodium-containing transition metal oxide, which contains a large amount of sodium, sodium deposits on the negative electrode as the charge and discharge operations are repeated. This may cause micro-short circuits in the battery, and, as a consequence, the battery performance may degrade. Moreover, the resistance of the negative electrode becomes high. On the other hand, such problems can be inhibited when using the lithium-containing transition metal oxide, which contains either no sodium or only a small amount of sodium.

It is desirable that the lithium-containing transition metal oxide be prepared by ion-exchanging part or all of sodium with lithium in a sodium-containing transition metal oxide, and the lithium-containing transition metal oxide be represented by the compositional formula NaₐLi_{b}MO_{2±α}, where 0≦a<0.1, 0.5≦b≦1.0, 0≦α≦0.1, and M is at least one element selected from the group consisting of Ni, Co, and Mn. More preferably, it is desirable that a+b be less than 1.0 in the foregoing formula.

When using the material in which part or all of sodium is ion-exchanged with lithium, the reversibility of lithium ions is improved further, and a high capacity non-aqueous electrolyte battery can be obtained.

It is desirable that the sodium-containing transition metal oxide be represented by the compositional formula NaₐLi_{b}MO_{2±α}, 0.5≦a<1.0, 0<b≦0.3, 0.5<a+b<1.0, 0≦α≦0.1, and M is at least one element selected from the group consisting of Ni, Co, and Mn.

It is desirable that the sodium-containing transition metal oxide be represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1, and the lithium-containing transition metal oxide be represented by the compositional formula NaₐLi_{b}Co_{c}Mn_{d}O₂, where 0≦a<0.1, 0.5≦b≦1.0, 0≦c≦1, 0≦d≦1, and 0.8≦c+d≦1.1, more preferably a+b<1.0.

It is also desirable that the positive electrode active material be represented by the compositional formula NaₐLi_{b}Co_{c}Mn_{d}O₂, where 0≦a<0.1, 0.5≦b≦1.2, 0≦c≦1, 0≦d≦1, and 0.8≦c+d≦1.1.

It is desirable that the sodium-containing transition metal oxide be represented by the compositional formula Li_{0.1}Na_{0.7}Co_{0.5}Mn_{0.5}O₂, the lithium-containing transition metal oxide be represented by the compositional formula Li_{0.8}Co_{0.5}Mn_{0.5}O₂, and the positive electrode active material be a lithium pre-doped transition metal oxide being represented by the compositional formula Li_{0.9}Co_{0.5}Mn_{0.5}O₂.

The just-mentioned lithium pre-doped transition metal oxide has an O2 structure with a space group P6₃mc. When using this material as the positive electrode active material, it shows a reversible charge-discharge reaction in which lithium is desorbed to Li_{0.2}Co_{0.5}Mn_{0.5}O₂ by charging and thereafter absorbed to Li_{1.1}Co_{0.5}Mn_{0.5}O₂, making it possible to increase the capacity of the positive electrode.

It is desirable that the negative electrode active material comprise a carbon material.

When a carbon material is used as the negative electrode active material, the negative electrode capacity is increased.

It is desirable that in the pre-doping of lithium, lithium be pre-doped in an amount that exceeds an irreversible capacity of the negative electrode.

When the pre-doping is performed in this way, the initial charge-discharge efficiency can be further improved. A graphite material, which is commonly used as the negative electrode active material, shows an irreversible capacity of from 4% to 8%. Therefore, it is preferable to pre-dope lithium in an amount of 4% or greater, more preferably 8% or greater.

The invention also provides a non-aqueous electrolyte battery comprising: a positive electrode having a positive electrode active material; a negative electrode containing lithium prior to initial charge and discharge; and a non-aqueous electrolyte containing lithium, wherein the positive electrode active material comprises a lithium pre-doped transition metal oxide prepared by pre-doping lithium into a sodium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0.5≦a<1.0, 0<b≦0.5, 0≦α≦0.1, and M is at least one element selected from the group consisting of Ni, Co, and Mn.

Since the sodium-containing transition metal oxide represented by such a compositional formula has a layered structure, the reversibility in the initial charge and discharge improves, and moreover, the crystal structure is stable even when charged to a high potential of 4.5 V or higher versus metallic lithium. As a result, a non-aqueous electrolyte battery with excellent cycle performance can be obtained. Moreover, by pre-doping the sodium-containing transition metal oxide with lithium, the amount of lithium in the negative electrode active material containing lithium can be reduced. This suppresses an increase in the thickness of the negative electrode and thereby prevents the resulting decrease in the capacity density of the battery.

It is desirable that the sodium-containing transition metal oxide be represented by the compositional formula NaₐLi_{b}MO_{2±α}, 0.5≦a<1.0, 0<b≦0.3, 0.5<a+b<1.0, 0≦α≦0.1, and M is at least one element selected from the group consisting of Ni, Co, and Mn.

It is desirable that the sodium-containing transition metal oxide be represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1, and the positive electrode active material be represented by the compositional formula NaₐLi_{b}Co_{c}Mn_{d}O₂, where 0.5≦a<1.0, 0<b≦0.5, 0≦c≦1, 0≦d≦1, and 0.8≦c+d≦1.1.

The invention also provides a non-aqueous electrolyte battery comprising: a positive electrode having a positive electrode active material, a negative electrode having a negative electrode active material containing lithium prior to initial charge and discharge, and a non-aqueous electrolyte containing lithium, wherein the positive electrode active material comprises a lithium pre-doped transition metal oxide prepared by pre-doping lithium into a lithium-containing transition metal oxide having an initial charge-discharge efficiency of higher than 100%, wherein the lithium pre-doped transition metal oxide is represented by the compositional formula NaₐLi_{b}MO_{2±α}, where 0≦a<0.1, 0.5≦b≦1.2, 0≦α≦0.1, and M is at least one element selected from the group consisting of Ni, Co, and Mn.

It is desirable that the lithium-containing transition metal oxide be prepared by ion-exchanging part or all of sodium with lithium in a sodium-containing transition metal oxide, and the lithium-containing transition metal oxide be represented by the compositional formula NaₐLi_{b}MO_{2±α}, where 0≦a<0.1, 0.5≦b≦1.0, 0≦α≦0.1, and M is at least one element selected from the group consisting of Ni, Co, and Mn. More preferably, it is desirable that a+b be less than 1.0 in the foregoing formula.

It is desirable that the sodium-containing transition metal oxide be represented by the compositional formula NaₐLi_{b}MO_{2±α}, 0.5≦a<1.0, 0<b≦0.3, 0.5<a+b<1.0, 0≦α≦0.1, and M is at least one element selected from the group consisting of Ni, Co, and Mn.

It is desirable that the sodium-containing transition metal oxide be represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1, and the lithium-containing transition metal oxide be represented by the compositional formula NaₐLi_{b}Co_{c}Mn_{d}O₂, where 0≦a<0.1, 0.5≦b≦1.0, 0≦c≦1, 0≦d≦1, and 0.8≦c+d≦1.1, more preferably a+b<1.0.

It is also desirable that the positive electrode active material be represented by the compositional formula NaₐLi_{b}Co_{c}Mn_{d}O₂, where 0≦a<0.1, 0.5≦b≦1.2, 0≦c≦1, 0≦d≦1, and 0.8≦c+d≦1.1.

It is desirable that the sodium-containing transition metal oxide be represented by the compositional formula Li_{0.1}Na_{0.7}Co_{0.5}Mn_{0.5}O₂, the lithium-containing transition metal oxide be represented by the compositional formula Li_{0.8}Co_{0.5}Mn_{0.5}O₂, and the positive electrode active material be a lithium pre-doped transition metal oxide represented by the compositional formula Li_{0.9}Co_{0.5}Mn_{0.5}O₂.

It is desirable that an organic compound that forms a complex with metallic lithium be used in the pre-doping of lithium.

The lithium pre-doping may be performed by an electrochemical means. However, the pre-doping can be performed more easily by the above-described method than by the electrochemical means, and, moreover, lithium can be pre-doped over the whole positive electrode active material uniformly.

It is preferable that the organic compound comprise at least one compound selected from the group consisting of naphthalene, phenanthrene, and 2-methyl-THF.

These substances can be handled easily, so the workability in the lithium pre-doping.

### DESCRIPTION OF THE PREFERRED EMBODIMENTS

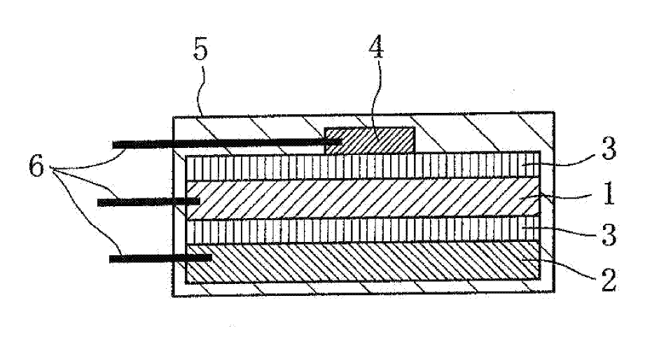

Hereinbelow, preferred embodiments of the non-aqueous electrolyte battery according to the invention will be described with reference to FIG. 1. It should be construed, however, that the non-aqueous electrolyte battery according to this invention is not limited to the following embodiments and examples but various changes and modifications are possible without departing from the scope of the invention.

### Preparation of Working Electrode

First, sodium carbonate (Na₂CO₃), lithium carbonate (Li₂CO₃), cobalt oxide (Co₃O₄), and manganese oxide (Mn₂O₃) were prepared as the starting materials. The materials were mixed so that the ratio (molar ratio) of Na:Li:Co:Mn became 0.7:0.1:0.5:0.5. Next, the mixed powder was formed into pellets, then pre-sintered in the air at 700° C. for 10 hours, and thereafter sintered in the air at 800° C. for 20 hours, to thereby obtain a sodium-containing transition metal oxide to which lithium was added, represented by the foregoing compositional formula. Because the sodium-containing transition metal oxide after the sintering contained impurities, a water washing treatment was conducted to remove the impurities after the sodium-containing transition metal oxide was synthesized.

Next, the resulting sodium-containing transition metal oxide was subjected to an ion-exchange of sodium for lithium using a fused salt of lithium nitrate and lithium chloride. In more detail, 3 g of the sodium-containing transition metal oxide was added to 10 g of a mixture of lithium nitrate and lithium chloride (mixed at a ratio of 88 mol %:12 mol %), and the mixture was kept at 280° C. for 10 hours to cause the reaction. Thereafter, the resultant material was washed with water to remove nitrates, chloride salts, and unreacted products of the starting materials, and vacuum dried at 100° C., to obtain a lithium-containing transition metal oxide. The resultant lithium-containing transition metal oxide has a composition of Li_{0.8}Co_{0.5}Mn_{0.5}O₂.

Thereafter, the resultant lithium-containing transition metal oxide was pre-doped with lithium using a naphthalene solution. In more detail, to a solution in which 1 mol/L of metallic lithium was dissolved in a dimethyl ether solution containing 1 mol/L of naphthalene, 1 mol/L of the foregoing lithium-containing transition metal oxide was added and immersed for 24 hours or longer to cause a reaction. Next, the immersed substance was filtered and washed with diethyl carbonate to remove naphthalene, and then vacuum dried at 60° C., to obtain a lithium pre-doped transition metal oxide that is the positive electrode active material. The resultant lithium pre-doped transition metal oxide has a composition of Li_{0.9}Co_{0.5}Mn_{0.5}O₂. Lithium insertion due to the pre-doping process was confirmed because the amount of lithium in the resultant lithium pre-doped transition metal oxide was greater than that in the foregoing lithium-containing transition metal oxide.

The lithium-containing transition metal oxide and the lithium pre-doped transition metal oxide were analyzed by powder X-ray diffraction analysis for phase identification. It was found that both substances had an O2 structure belonging to the space group P6₃mc. In contrast, the foregoing sodium transition metal oxide had a P2 structure.

Using the lithium pre-doped transition metal oxide prepared in the above-described manner as the positive electrode active material, 80 parts by weight of the positive electrode active material was mixed with 10 parts by weight of acetylene black as a conductive agent and 10 parts by weight of polyvinylidene fluoride as a binder agent, and N-methyl-2-pyrrolidone was added to the mixture to form a slurry. The slurry was applied onto one side of a current collector made of an aluminum foil. The resultant material was dried, then calendered, and cut into a plate shape with a size of 2 cm×2.5 cm. Then, a positive electrode tab was attached thereto, to complete a positive electrode. This positive electrode was used as a working electrode.

### Preparation of Counter Electrode and Reference Electrode

A metallic lithium plate was cut into a predetermined size, and a tab was attached thereto, to thereby prepare a counter electrode 2 (negative electrode) and a reference electrode 4.

### Preparation of Non-Aqueous Electrolyte

A non-aqueous electrolyte was prepared by dissolving lithium hexafluorophosphate (LiPF₆) at a concentration of 1 mol/L in a mixed solvent of 3:7 volume ratio of ethylene carbonate (EC) and diethyl carbonate (DEC) were mixed in a volume ratio of 3:7.

### Preparation of Test Cell

Under an inert atmosphere, a counter electrode 2, a separator 3 made of microporous polyethylene film, a working electrode 1, a separator 3, and a reference electrode 4 were placed in a test cell container 5 made of a laminate film. Then, the above-described non-aqueous electrolyte was filled in the test cell container 5. Thus, a test cell as shown in FIG. 1 was prepared. Leads 6 were disposed in such a manner that a portion of each of the leads 6 protrudes from the test cell container 5.

### Other Embodiments

(1) The method of ion-exchanging is not limited to the above-described method. It is possible that part or all of the sodium in the sodium-containing transition metal oxide may be ion-exchanged using fused salts, organic solvents, aqueous solutions and the like that contain a lithium compound.

The lithium compound used for the ion-exchanging may be nitrate, carbonate, acetate, halide, and hydroxide, for example. These may be used either alone or in combination, as necessary. It is preferable that a lithium nitrate and a lithium chloride be used in combination. It is preferable that the ion-exchanging be performed at a temperature of from 140° C. to 400° C., more preferably from 250° C. to 350° C.

Examples of the organic solvent used for the ion-exchange include alcohols such as n-hexanol.

(2) The method of the pre-doping is not limited to the above-described method. Any method may be used as long as it is carried out by using an organic compound that forms a complex by transferring electrons from lithium. The pre-doping may be carried out by bringing powder of a lithium-containing transition metal oxide or an electrode containing a lithium-containing transition metal oxide into contact with the organic compound that forms a complex with lithium.

Examples of the organic compound include hydrocarbon compounds including acenes, acene-related substances, amines, cyclic ethers, cyclic polyethers, cyclic polyether amines, cyclic polyamines, noncyclic polyethers, polyaminocarboxylic acids, polyaminophosphoric acids, and oxycarbonic acids. Examples of the acenes include naphthalene, anthracene, phenanthrene, and azulene. Examples of the acene-related substances include benzophenone, biphenyl, acetophenone, naphthoquinone, and anthraquinone. Examples of the amines include ethylenediamine, triethylamine, hexamethylphosphoric triamide, and tetramethylethylenediamine. Examples of the cyclic ethers include 2-methyl-tetrahydrofuran and the like. Examples of the cyclic polyethers include 12-crown-4,15-crown-5,18-crown-6, benzo-12-crown-4, benzo-15-crown-5, benzo-18-crown-6, dibenzo-12-crown-4, dibenzo-15-crown-5, dicyclohexyl-12-crown-4, dicyclohexyl-15-crown-5, dicyclohexyl-18-crown-6, n-octyl-12-crown-4, n-octyl-15-crown-5, and n-octyl-18-crown-6. Examples of the cyclic polyether amines include cryptand and derivatives thereof. Examples of the cyclic polyamines include 1,4,7,10,13,16-hexaazacyclooctadecane, and 8-azaadenine. Examples of the noncyclic polyethers include polyethylene glycol, polyethylene glycol monoalkyl ether, and polypropylene glycol. Examples of the polyaminocarboxylic acids include ethylenediaminetetraacetic acid, iminodiacetic acid, nitrilotriacetic acid, hydroxyethylimino diacetic acid, trans-1,2-diaminocyclohexane-N,N,N′,N′-tetraacetic acid, ethylenediethyltriamine-N,N,N′,N,N-pentaacetic acid, hydroxyethylethylenediamine triacetic acid, and dihydroxyethylglycine. Examples of the polyaminophosphoric acids include ethylenediaminetetrakis(methylenesulfonic acid) and nitrilotris(methylene sulfonic acid). Examples of the oxycarbonic acids include citric acid and the like. Preferable among them are naphthalene, phenanthrene, and 2-methyl-tetrahydrofuran, which are aromatic.

(3) It is preferable to use a material capable of intercalating and deintercalating lithium as the negative electrode active material. Examples include metallic lithium, lithium alloys, carbonaceous substances, and metallic compounds. These negative electrode active materials may be used either alone or in combination.

Examples of the lithium alloys include lithium-aluminum alloy, lithium-silicon alloy, lithium-tin alloy, and lithium-magnesium alloy.

Examples of the carbonaceous substances capable of intercalating and deintercalating lithium include natural graphite, artificial graphite, coke, vapor grown carbon fibers, mesophase pitch-based carbon fibers, spherical carbon, and resin-sintered carbon.

(4) Examples of the solvent of the non-aqueous electrolyte used in the present invention include cyclic carbonic esters, chain carbonic esters, esters, cyclic ethers, chain ethers, nitriles, and amides. Examples of the cyclic carbonic esters include ethylene carbonate, propylene carbonate and butylenes carbonate. It is also possible to use a cyclic carbonic ester in which part or all of the hydrogen groups of the cyclic carbonic esters is/are fluorinated. Examples of such include trifluoropropylene carbonate and fluoroethylene carbonate. Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated. Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether. Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether. Examples of the nitriles include acetonitrile. Examples of the amides include dimethylformamide. These substances may be used either alone or in combination.

(5) The lithium salt to be added to the non-aqueous solvent may be any lithium salt commonly used as the electrolyte in conventional non-aqueous electrolyte batteries. Examples include LiPF₆, LiBF₄, LiAsF₆, LiClO₄, LiCF₃SO₃, LiN(FSO₂)₂, LiN(CₗF₂ₗ₊₁SO₂)(CₘF₂ₘ₊₁SO₂) (where 1 and m are integers equal to or greater than 1), LiC(CₚF₂ₚ₊₁ SO₂)(C_{q}F_{2q+1}SO₂)(CᵣF₂ᵣ₊₁SO₂) (where p, q, and r are integers equal to or greater than 1), Li[B(C₂O₄)₂] (lithium bis(oxalato)borate (LiBOB)), Li[B(C₂O₄)F₂], Li[P(C₂O₄)F₄], and Li[P(C₂O₄)₂F₂]. These lithium salts may be used either alone or in combination.

(6) In addition to the positive electrode active material, the negative electrode active material, and the non-aqueous electrolyte as described above, the non-aqueous electrolyte battery according to the present invention may comprise other battery components, such as a separator, a battery case, and a current collector serving to retain active material and perform current collection. The components other than the negative electrode active material and the electrolyte are not particularly limited, and various known components may be selectively used.

### EXAMPLES

### Preliminary Experiment

Prior to carrying out the experiments shown in the following two examples, the irreversible capacity of a carbon negative electrode was measured as a preliminary experiment. The result is shown in Table 1. The cell used in the preliminary experiment was prepared in the following manner.

### Preparation of Test Cell

First, 98 parts by weight of graphite as a negative electrode active material, 1 part by weight of carboxymethylcellulose as a thickening agent, and 1 part by weight of styrene-butadiene rubber as a binder agent were mixed together, and water was added to the mixture to prepare a slurry. The slurry was applied onto one side of a current collector made of a copper foil. The resultant material was dried, then calendered, and cut into a plate shape with a size of 2 cm×2.5 cm. Then, a negative electrode tab was attached thereto, to complete a negative electrode. This negative electrode was used as a working electrode.

Metallic lithium with a predetermined size was used for the counter electrode and the reference electrode.

The non-aqueous electrolyte used was prepared as follows. Lithium hexafluorophosphate as an electrolyte salt was added at a concentration of 1 mol/L to a non-aqueous solvent of 30:70 volume ratio mixture of ethylene carbonate and diethyl carbonate.

A test cell was prepared using the working electrode, the counter electrode, and the non-aqueous electrolyte that were prepared as described above. A microporous polyethylene film was used as the separator, and the separator was impregnated with the above-described non-aqueous electrolyte.

### Details of the Experiment

The prepared test cell of the non-aqueous electrolyte battery was charged with a constant current at a current density of 0.5 mA/cm² (corresponding to 0.2 It) until the potential of the working electrode versus the reference electrode reached 0 V, and thereafter charged with a constant current at a current density of 0.25 mA/cm² (corresponding to 0.1 It) until the potential of the working electrode versus the reference electrode reached 0 V. Thereafter, the cell was further charged with a constant current at a current density 0.1 mA/cm² (corresponding to 0.04 It) until the potential of the working electrode versus the reference electrode reached 0 V. The capacities obtained were totaled to calculate the charge capacity Q1 per unit weight of negative electrode active material.

Next, the cell was discharged with a constant current at a current density of 0.25 mA/cm² (corresponding to 0.1 It) until the potential of the working electrode versus the reference electrode reached 1 V, to obtain the discharge capacity Q2 per unit weight of the negative electrode active material.

Lastly, the initial charge-discharge efficiency was calculated using the following equation (1).

Initial charge-discharge efficiency of the negative electrode=(Q2/Q1)×100 (1)

TABLE 1

| Initial charge | | Initial charge-discharge |
|---|---|---|
| capacity Q1 | Initial discharge capacity Q2 | efficiency |
| (mAh/g) | (mAh/g) | (%) |
| 364 | 347 | 95.3 |

As shown in Table 1, the initial charge-discharge efficiency was 95.3%. Thus, it is understood that the irreversible capacity ratio of the graphite negative electrode is 4.7% (100%−95.3%).

### First Example Group

### Example

A test cell was prepared according to the same manner as described in the foregoing embodiment.

The test cell prepared in this manner is hereinafter referred to as a present invention cell A.

### Comparative Example

A test cell was prepared in the same manner as described in the example above, except that the lithium-containing transition metal oxide was not subjected to the pre-doping process (i.e., the lithium-containing transition metal oxide represented by the compositional formula Li_{0.8}Co_{0.5}Mn_{0.5}O₂ was used as the positive electrode active material).

The test cell prepared in this manner is hereinafter referred to as a comparative cell X.

### Experiment

The present invention cell A and the comparative cell X were charged and discharged under the following conditions to determine the charge capacity Q3 per unit weight of positive electrode active material (hereinafter simply referred to as the charge capacity Q3) and the discharge capacity Q4 per unit weight of positive electrode active material (hereinafter simply referred to as the discharge capacity Q4). From the results, the initial charge-discharge efficiency of each of the cells was calculated according to the following equation (2). The results are shown in Table 2 below.

Charge

Each of the cells was charged with a constant current at a current density of 15 mA/g (corresponding to 0.05 It) until the potential of the working electrode versus the reference electrode reached 5 V, to obtain the charge capacity Q3.

Discharge

After conducting the above charging, each of the cells was discharged with a constant current at a current density of 15 mA/g (corresponding to 0.05 It) until the potential of the working electrode versus the reference electrode reached 2 V, to obtain the discharge capacity Q4.

Equation for Calculating Initial Charge-Discharge Efficiency

Initial charge-discharge efficiency=(Q4/Q3)×100 (2)

TABLE 2

| | | Negative | Charge | Discharge | Initial charge- |
|---|---|---|---|---|---|
| | | electrode | capacity | capacity | discharge |
| | | active | Q3 | Q4 | efficiency |
| Cell | Pre-doping | material | (mAh/g) | (mAh/g) | (%) |
| A | Yes | Metallic | 201.8 | 207.1 | 102.6 |
| X | No | lithium | 180.6 | 243.0 | 134.5 |

Generally, when a transition metal oxide having an O3 structure, such as LiCoO₂ or LiNiO₂, is used as the positive electrode active material, the initial charge-discharge efficiency is 100% or less. Therefore, if such a positive electrode active material is doped with lithium, only the charge capacity increases, and the charge-discharge efficiency decreases [because, in the above equation (2), the denominator, which is the charge capacity Q3, increases, while the numerator, which is the discharge capacity Q4, remains unchanged].

However, when Li_{0.8}Co_{0.5}Mn_{0.5}O₂ with an O2 structure is used as the positive electrode active material, the comparative cell X, in which the positive electrode active material is not doped with lithium, shows a higher discharge capacity Q4, and the initial charge-discharge efficiency is 134.5%. Therefore, when the battery is constructed using this positive electrode active material and a negative electrode active material containing lithium prior to initial charge and discharge, such as lithium or a lithium alloy, it is necessary that the negative electrode should contain lithium in an amount corresponding to the proportion of the initial charge-discharge efficiency that exceeds 100%. This means that the thickness of the negative electrode becomes greater, resulting in a decrease in the capacity density of the battery. Moreover, when the battery is constructed using this positive electrode active material and a negative electrode active material that does not contain lithium prior to initial charge and discharge, such as graphite, the battery suffers problems such as insufficient battery performance, as described in the following second example group.

In contrast, the present invention cell A, in which lithium is doped, shows a higher charge capacity Q3 than the comparative cell X, and in addition, it shows an initial charge-discharge efficiency of 102.6%, which is a significant improvement in the reversibility in the initial charge and discharge over the comparative cell X. Therefore, the present invention cell A can avoid the problems with the comparative cell X. The lithium-containing transition metal oxide prior to the lithium doping (i.e., the positive electrode active material used in the comparative cell X) is in a state in which the interlayer lithium is deficient. Therefore, it shows a high discharge capacity relative to the charge capacity. On the other hand, in the lithium pre-doped transition metal oxide in which lithium is doped into the lithium-containing transition metal oxide (i.e., the positive electrode active material used in the present invention cell A), the deficient lithium is supplemented by the pre-doping, and the structure is stabilized. As a result, the charge-discharge efficiency is improved.

The pre-doping amount of the positive electrode active material in the present invention cell A is 21.2 mAh/g, so the ratio thereof to the charge capacity prior to the doping is 11.7% [(21.2/180.6)×100%]. This is greater than the irreversible capacity ratio (4.7%) of the graphite negative electrode as seen from Table 1 above.

### Second Example Group

### Example

A test cell was prepared in the same manner as in described in the above example of the first example group, except that the negative electrode was prepared in the following manner.

First, 98 parts by weight of graphite, 1 part by weight of carboxymethylcellulose as a thickening agent, and 1 part by weight of styrene-butadiene rubber as a binder agent were mixed together, and water was added to the mixture to prepare a slurry. The slurry was applied onto one side of a current collector made of a copper foil. The resultant material was dried, then calendered, and cut into a plate shape with a size of 2 cm×2.5 cm. Then, a negative electrode tab was attached thereto, to complete a negative electrode.

The test cell prepared in this manner is hereinafter referred to as a present invention cell B.

### Comparative Example

A test cell was prepared in the same manner as described in the example above, except that the lithium-containing transition metal oxide was not subjected to the pre-doping process (i.e., the lithium-containing transition metal oxide represented by the compositional formula Li_{0.8}Co_{0.5}Mn_{0.5}O₂ was used as the positive electrode active material).

The test cell prepared in this manner is hereinafter referred to as a comparative cell Y.

### Experiment

The present invention cell B and the comparative cell Y were charged and discharged under the following conditions to determine the charge capacity Q5 per unit weight of positive electrode active material (hereinafter simply referred to as the charge capacity Q5) and the discharge capacity Q6 per unit weight of positive electrode active material (hereinafter simply referred to as the discharge capacity Q6). From the results, the initial charge-discharge efficiency of each of the cells was calculated according to the following equation (3). The results are shown in Table 3 below.

Charge

Each of the cells was charged with a constant current at a current density of 15 mA/g (corresponding to 0.05 It) until the battery voltage reached 4.9 V, to obtain the charge capacity Q5.

Discharge

After conducting the above charging, each of the cells was discharged with a constant current at a current density of 15 mA/g (corresponding to 0.05 It) until the battery voltage reached 2 V, to obtain the discharge capacity Q6.

Equation for Calculating Initial Charge-Discharge Efficiency

Initial charge-discharge efficiency=(Q6/Q5)×100 (3)

TABLE 3

| | | Negative | Charge | Discharge | Initial charge- |
|---|---|---|---|---|---|
| | | electrode | capacity | capacity | discharge |
| | | active | Q5 | Q6 | efficiency |
| Cell | Pre-doping | material | (mAh/g) | (mAh/g) | (%) |
| B | Yes | Graphite | 198.7 | 161.7 | 81.4 |
| Y | No | | 179.9 | 137.4 | 76.4 |

As clearly seen from Table 3 above, the present invention cell B and the comparative cell Y, in which graphite was used as the negative electrode active material, showed lower initial charge-discharge efficiencies than the present invention cell A and the comparative cell X, in which metallic lithium was used as the negative electrode active material. However, it was observed that the present invention cell B, in which the positive electrode active material was pre-doped with lithium, exhibited a higher initial charge-discharge efficiency and also a higher discharge capacity Q6 than the comparative cell Y, in which the positive electrode active material was not pre-doped with lithium.

The present invention may be applicable to, for example, power sources for mobile information terminals such as mobile telephones, notebook computers, PDAs power tools, power assisted bicycles, EVs and HEVs.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte battery comprising: a positive electrode having a positive electrode active material; a negative electrode that does not contain lithium prior to initial charge and discharge; and a non-aqueous electrolyte containing lithium, wherein the positive electrode active material comprises a lithium pre-doped transition metal oxide prepared by pre-doping lithium into a sodium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0.5≦a<1.0, 0<b≦0.5, 0≦α≦0.1, and M is at least one element selected from the group consisting of Ni, Co, and Mn.

2. The non-aqueous electrolyte battery according to claim 1, wherein the sodium-containing transition metal oxide is represented by the compositional formula NaₐLi_{b}MO_{2±α}, where 0.5≦a<1.0, 0<b≦0.3, 0.5<a+b<1.0, 0≦α≦0.1, and M is at least one element elected from the group consisting of Ni, Co, and Mn.

3. The non-aqueous electrolyte battery according to claim 2, wherein: the sodium-containing transition metal oxide is represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1; and the positive electrode active material is represented by the compositional formula NaₐLi_{b}Co_{c}Mn_{d}O₂, where 0.5≦a<1.0, 0<b≦0.5, 0≦c≦1, 0≦d≦1, and 0.8≦c+d≦1.1.

4. A non-aqueous electrolyte battery comprising: a positive electrode having a positive electrode active material; a negative electrode that does not contain lithium prior to initial charge and discharge; and a non-aqueous electrolyte containing lithium, wherein the positive electrode active material comprises a lithium pre-doped transition metal oxide prepared by pre-doping lithium into a lithium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0≦a<0.1, 0.5≦b≦1.2, 0≦α≦0.1, and M is at least selected from the group consisting of Ni, Co, and Mn.

5. The non-aqueous electrolyte battery according to claim 4, wherein the lithium-containing transition metal oxide is prepared by ion-exchanging part or all of sodium with lithium in a sodium-containing transition metal oxide, and the lithium-containing transition metal oxide is represented by the compositional formula NaₐLi_{b}MO_{2±α}, where 0≦a<0.1, 0.5≦b≦1.0, 0≦α≦0.1, and M is at least one element selected from the group consisting of Ni, Co, and Mn.

6. The non-aqueous electrolyte battery according to claim 1, wherein the sodium-containing transition metal oxide is represented by the compositional formula NaₐLi_{b}MO_{2±α}, where 0.5≦a<1.0, 0<b≦0.3, 0.5<a+b<1.0, 0≦α≦0.1, and M is at least one element elected from the group consisting of Ni, Co, and Mn.

7. The non-aqueous electrolyte battery according to claim 6, wherein: the sodium-containing transition metal oxide is represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1; the lithium-containing transition metal oxide is represented by the compositional formula NaₐLi_{b}Co_{c}Mn_{d}O₂, where 0≦a<0.1, 0.5≦b≦1.0, 0≦c≦1, 0≦d≦1, and 0.8≦c+d≦1.1; and the positive electrode active material is represented by the compositional formula NaₐLi_{b}Co_{c}Mn_{d}O₂, where 0≦a<0.1, 0.5≦b≦1.2, 0≦c≦1, 0≦d≦1, and 0.8≦c+d≦1.1.

8. The non-aqueous electrolyte battery according to claim 7, wherein the sodium-containing transition metal oxide is represented by the compositional formula Li_{0.1}Na_{0.7}Co_{0.5}Mn_{0.5}O₂; the lithium-containing transition metal oxide is represented by the compositional formula Li_{0.8}Co_{0.5}Mn_{0.5}O₂; and the positive electrode active material is a lithium pre-doped transition metal oxide represented by the compositional formula Li_{0.9}Co_{0.5}Mn_{0.5}O₂.

9. The non-aqueous electrolyte battery according to claim 8, wherein the negative electrode active material comprises a carbon material.

10. The non-aqueous electrolyte battery according to claim 1, wherein, in the pre-doping of lithium, lithium is pre-doped in an amount that exceeds an irreversible capacity of the negative electrode.

11. A non-aqueous electrolyte battery comprising: a positive electrode having a positive electrode active material; a negative electrode containing lithium prior to initial charge and discharge; and a non-aqueous electrolyte containing lithium, wherein the positive electrode active material comprises a lithium pre-doped transition metal oxide prepared by pre-doping lithium into a sodium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0.5≦a<1.0, 0<b≦0.5, 0≦α≦0.1, and M is at least one element selected from the group consisting of Ni, Co, and Mn.

12. The non-aqueous electrolyte battery according to claim 11, wherein the sodium-containing transition metal oxide is represented by the compositional formula NaₐLi_{b}MO_{2±α}, where 0.5≦a<1.0, 0<b≦0.3, 0.5<a+b<1.0, 0≦α≦0.1, and M is at least one element elected from the group consisting of Ni, Co, and Mn.

13. The non-aqueous electrolyte battery according to claim 12, wherein: the sodium-containing transition metal oxide is represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1; and the positive electrode active material is represented by the compositional formula NaₐLi_{b}Co_{c}Mn_{d}O₂, where 0.5≦a<1.0, 0<b≦0.5, 0≦c≦1, 0≦d≦1, and 0.8≦c+d≦1.1.

14. A non-aqueous electrolyte battery comprising: a positive electrode having a positive electrode active material; a negative electrode containing lithium prior to initial charge and discharge; and a non-aqueous electrolyte containing lithium, wherein the positive electrode active material comprises a lithium pre-doped transition metal oxide prepared by pre-doping lithium into a lithium-containing transition metal oxide having an initial charge-discharge efficiency of higher than 100%, as determined by charging and discharging using a lithium metal negative electrode as a counter electrode, wherein the lithium pre-doped transition metal oxide is represented by the compositional formula NaₐLi_{b}MO_{2±α}, where 0≦a<0.1, 0.5≦b≦1.2, 0≦α≦0.1, and M is at least selected from the group consisting of Ni, Co, and Mn.

15. The non-aqueous electrolyte battery according to claim 14, wherein the lithium-containing transition metal oxide is prepared by ion-exchanging part or all of sodium with lithium in a sodium-containing transition metal oxide, and the lithium-containing transition metal oxide is represented by the compositional formula NaₐLi_{b}MO_{2±α}, where 0≦a<0.1, 0.5≦b≦1.0, 0≦α≦0.1, and M is at least one element selected from the group consisting of Ni, Co, and Mn.

16. The non-aqueous electrolyte battery according to claim 15, wherein the sodium-containing transition metal oxide is represented by the compositional formula NaₐLi_{b}MO_{2±α}, where 0.5≦a<1.0, 0<b≦0.3, 0.5<a+b<1.0, 0≦α≦0.1, and M is at least one element elected from the group consisting of Ni, Co, and Mn.

17. The non-aqueous electrolyte battery according to claim 16, wherein: the sodium-containing transition metal oxide is represented by the compositional formula NaₐLi_{b}Co_{c}Mn_{d}O₂, where 0.5≦a<1.0, 0<b≦0.3, 0.5<a+b<1.0, 0≦c≦1, 0≦d≦1, and 0.8≦c+d≦1.1; the lithium-containing transition metal oxide is represented by the compositional formula NaₐLi_{b}Co_{c}Mn_{d}O₂, where 0≦a<0.1, 0.5≦b≦1.0, 0≦c≦1, 0≦d≦1, and 0.8≦c+d≦1.1; and the positive electrode active material is represented by the compositional formula NaₐLi_{b}Co_{c}Mn_{d}O₂, where 0≦a<0.1, 0.5≦b≦1.2, 0≦c≦1, 0≦d≦1, and 0.8≦c+d≦1.1.

18. The non-aqueous electrolyte battery according to claim 17, wherein the sodium-containing transition metal oxide is represented by the compositional formula Li_{0.1}Na_{0.7}Co_{0.5}Mn_{0.5}O₂; the lithium-containing transition metal oxide is represented by the compositional formula Li_{0.8}Co_{0.5}Mn_{0.5}O₂; and the positive electrode active material is a lithium pre-doped transition metal oxide represented by the compositional formula Li_{0.9}Co_{0.5}Mn_{0.5}O₂.

19. The non-aqueous electrolyte battery according to claim 18, wherein an organic compound that forms a complex with metallic lithium is used in the pre-doping of lithium.

20. The non-aqueous electrolyte battery according to claim 19, wherein the organic compound comprises at least one compound selected from the group consisting of naphthalene, phenanthrene, and 2-methyl-THF.
